(19) United States
(12) Patent Application Publication
(10) Pub. No.: US 2025/0106898 A1
(43) Pub. Date: Mar. 27, 2025

(54) COVERAGE ENHANCEMENT METHOD AND RELATED DEVICES

(71) Applicant: TCL COMMUNICATION TECHNOLOGY (CHENGDU ) LIMITED, Chengdu (CN)

(72) Inventor: Yiwei DENG, Chengdu (CN)

(73) Assignee: TCL COMMUNICATION TECHNOLOGY (CHENGDU ) LIMITED, Chengdu (CN)

(21) Appl. No.: 18/728,470

(22) PCT Filed: Jan. 19, 2022
(86) PCT No.: PCT/CN2022/072809

§ 371 Date: Jul. 12, 2024

(51) Int. Cl. H04W 74/0833; H04L 5/00

(52) U.S. Cl. CPC H04W 74/0833; H04L 5/0007; H04L 5/0053

(57) ABSTRACT

A coverage enhancement method, performed by a user equipment (UE), includes being indicated with the number of Physical Random Access Channel (PRACH) repetitions and transmitting the PRACH repetitions based on the number of PRACH repetitions and a PRACH repetition pattern. The number of PRACH repetitions is indicated by a parameter of an information element (IE) carried in system information block 1 (SIB1).

### TECHNICAL FIELD

The present application relates to wireless communication technologies, and more particularly, to a coverage enhancement method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). More recently, LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

Coverage is one of the key factors that an operator considers when commercializing cellular communication networks due to its direct impact on service quality as well as Capital expenditures (CAPEX) and Operating expenses (OPEX). Despite the importance of coverage on the success of NR commercialization, a thorough coverage evaluation and a comparison with legacy Radio Access Technologies (RATs) considering all NR specification details have not been done up to now.

Compared to LTE, NR is designed to operate at much higher frequencies such as 28 GHZ or 39 GHz in FR2. Furthermore, many countries are making available more spectrums on FRI, such as 3.5 GHz, which is typically in higher frequencies than for LTE or 3G. Due to the higher frequencies, it is inevitable that the wireless channel will be subject to higher path-loss making it more challenging to maintain an adequate quality of service that is at least equal to that of legacy RATs. One key mobile application of particular importance is voice service for which a typical subscriber will always expect a ubiquitous coverage wherever s/he is.

For FR1, NR can be deployed either in newly allocated spectrums, such as 3.5 GHZ, or in a spectrum re-farmed from a legacy network, e.g., 3G and 4G. In either case, coverage will be a critical issue considering the fact that these spectrums will most likely handle key mobile services such as voice and low-rate data services. For FR2, coverage was not thoroughly evaluated during the self-evaluation campaign towards IMT-2020 submission and not considered in Rel-16 enhancements. In these regards, a thorough understanding of NR coverage performance is needed while taking into account the support of latest NR specification.

In 3GPP Rel-17, PRACH is identified as a bottleneck channel. Some proposed multiple PRACH transmissions with the same transmission beam or different beams. Unfortunately, due to time limitation, PRACH enhancement was not standardized. Potential methods of PRACH enhancement were proposed, but details were not discussed.

In RAN #94 meeting, a new Rel-18 work item on NR coverage enhancements was approved. The objective of this study item is to study potential coverage enhancement solutions for specific scenarios for both FRI and FR2. The detailed objectives are as follows.
Specify following PRACH coverage enhancements (RAN1, RAN2)
   Multiple PRACH transmissions with same beams for 4-step RACH procedure
   Study, and if justified, specify PRACH transmissions with different beams for 4-step RACH procedure
   Note 1: The enhancements of PRACH are targeting for FR2, and can also apply to FRI when applicable.
   Note 2: The enhancements of PRACH are targeting short PRACH formats, and can also apply to other formats when applicable.
Study and if necessary specify following power domain enhancements
   Enhancements to realize increasing UE power high limit for CA and DC based on Rel-17 RAN4 work on “Increasing UE power high limit for CA and DC”, in compliance with relevant regulations
      Note 1: The study starts after RAN4 work on “Increasing UE power high limit for CA and DC” is done depending on conclusions from RAN4.
      Note 2: The objective will be revisited and further clarified in RAN plenary after RAN4 work on “Increasing UE power high limit for CA and DC” is done, and the discussion in WGs will not start before the objective is revised with a clearer scope.
      Note 3: Both RAN1 and RAN4 are expected to be involved; to decide the order of either (RAN4, RAN1) or (RAN1, RAN4) later.
   Enhancements to reduce MPR/PAR, including frequency domain spectrum shaping with and without spectrum extension for DFT-S-OFDM and tone reservation
Specify enhancements to support dynamic switching between DFT-S-OFDM and CP-OFDM

In Rel-15 to 17, UL waveform is configured via RRC and this limitation imposes a large barrier to switch over to DFT-S-OFDM waveform for cell-edge UEs practically. DFT-S-OFDM waveform is beneficial for UL coverage limited scenarios because of its lower Peak-to-Average Power Ratio (PAPR) compared with CP-OFDM waveform. To achieve a better coverage performance, a method to support dynamic changing the UL waveform is needed.

There are still some issues need to carry out for coverage enhancement for uplink (UL) transmission.

### SUMMARY

The objective of the present application is to provide a coverage enhancement method and related devices, for carrying out coverage enhancement.

In a first aspect, an embodiment of the present application provides a coverage enhancement method, performed by a user equipment (UE), the method comprising: being indicated with the number of Physical Random Access Channel (PRACH) repetitions; and transmitting the PRACH repetitions based on the number of PRACH repetitions and a PRACH repetition pattern.

In a second aspect, an embodiment of the present application provides a coverage enhancement method, performed by a base station (BS), the method comprising: indicating a user equipment (UE) with the number of Physical Random Access Channel (PRACH) repetitions; and receiving from the UE the PRACH repetitions based on the number of PRACH repetitions and a PRACH repetition pattern.

In a third aspect, an embodiment of the present application provides a user equipment (UE), communicating with a base station (BS) in a network, the UE comprising a processor, configured to call and run program instructions stored in a memory, to execute a coverage enhancement method comprising: being indicated with the number of Physical Random Access Channel (PRACH) repetitions; and transmitting the PRACH repetitions based on the number of PRACH repetitions and a PRACH repetition pattern.

In a fourth aspect, an embodiment of the present application provides a base station (BS), communicating with a user equipment (UE) in a network, the BS comprising a processor, configured to call and run program instructions stored in a memory, to execute a coverage enhancement method comprising: indicating a user equipment (UE) with the number of Physical Random Access Channel (PRACH) repetitions; and receiving from the UE the PRACH repetitions based on the number of PRACH repetitions and a PRACH repetition pattern.

In a fifth aspect, an embodiment of the present application provides a computer readable storage medium provided for storing a computer program, which enables a computer to execute the method of any of the first and the second aspects.

In a sixth aspect, an embodiment of the present application provides a computer program product, which includes computer program instructions enabling a computer to execute the method of any of the first and the second aspects.

In a seventh aspect, an embodiment of the present application provides a computer program, when running on a computer, enabling the computer to execute the method of any of the first and the second aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic block diagram illustrating a communication network system according to an embodiment of the present application.

FIG. 2 is a flowchart of a coverage enhancement method according to an embodiment of the present application.

FIG. 3 is a schematic diagram illustrating PRACH repetition transmission in time domain ROs according to an embodiment of the present application.

FIG. 4 is a schematic diagram illustrating PRACH repetition transmission in frequency domain ROs according to an embodiment of the present application.

FIG. 5 is a schematic diagram illustrating PRACH repetition transmission in time and frequency domain ROs according to an embodiment of the present application.

FIG. 6 is a schematic diagram illustrating SSB mapping to time domain ROs according to an embodiment of the present application.

FIG. 7 is a schematic diagram illustrating SSB mapping to frequency domain ROs according to an embodiment of the present application.

FIG. 8 is a schematic diagram illustrating time and frequency domain ROs (time first) according to an embodiment of the present application.

FIG. 9 is a schematic diagram illustrating time and frequency domain ROs (frequency first) according to an embodiment of the present application.

FIG. 10 is a schematic diagram illustrating the number of PRACH repetitions based on nominal repetition according to an embodiment of the present application.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

Multiple PRACH transmissions with the same beams for 4-step RACH was approved in RAN #94 meeting; however, in current version (Rel-17) of 3GPP specification, a RACH occasion (RO) is indicated by SIB1 and a RACH sequence only occupies a RACH occasion to transmit and does not repeat. Thus, how to indicate the PRACH transmission with repetitions should be determined. Moreover, the relationship between RACH repetition transmission occasions and beam indexes should also be determined.

If multiple PRACH transmissions with same beam for 4-step RACH are enabled, the repetition pattern of PRACH should be determined (e.g., based on ROs or slots, whether the ROs is only time domain or not, etc.). In addition, when a RACH repetition is collided with frame structure, how to handle collision issue is also need to be determined.

DFT-S-OFDM waveform is beneficial for UL coverage limited scenarios because of its lower Peak-to-Average Power Ratio (PAPR) compared with CP-OFDM waveform. Currently, UL waveform is configured via RRC and this limitation imposes a large barrier to switch over to DFT-S-OFDM waveform for cell-edge UEs practically. So, a dynamic way to switch the waveform is needed.

In Rel-17, PRACH coverage enhancement has not been addressed, despite being identified as one of the bottleneck channels in the corresponding studies. PRACH transmission is very important for many procedures, e.g., initial access and beam failure recovery. To achieve better coverage performance, some enhancement methods will be needed. This disclosure proposes some coverage enhancement methods for PRACH channel. In Rel-15˜17, UL waveform is configured via RRC and this limitation imposes a large barrier to switch over to DFT-S-OFDM waveform for cell-edge UEs practically, this disclosure proposes a dynamic method to switch waveform for UL channel between CP-OFDM and DFT-S-OFDM such that better coverage performance will be achieved.

The invention of this disclosure can be summarized as below:
1. Methods to indicate the number of PRACH repetitions.
A parameter or an information element (IE) can be added into RACH-ConfigGeneric information element.
A new column can be added into the “Random access configurations” table defined in TS 38.211
2. Methods to determine PRACH repetition pattern.
PRACH repetition pattern is based on time domain ROs
PRACH repetition pattern is based on frequency domain ROs
PRACH repetition pattern is based on time and frequency domain ROs
3. Methods to determine the relationship between SSBs and multiple PRACH transmission occasions.
SSB is mapped to multiple time domain ROs
SSB is mapped to multiple frequency domain ROs
SSB is mapped to multiple time and frequency domain ROs
4. Methods to dynamic switching waveform for UL channels
Both types of waveforms are configured by introducing a new field in DCI for indicating the waveform for UL channels explicitly
Both types of waveforms are configured by indicating UL channel waveform by an implicit way
Both types of waveforms are configured by a reused field in DCI for indicating the waveform for UL channels explicitly.

FIG. 1 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

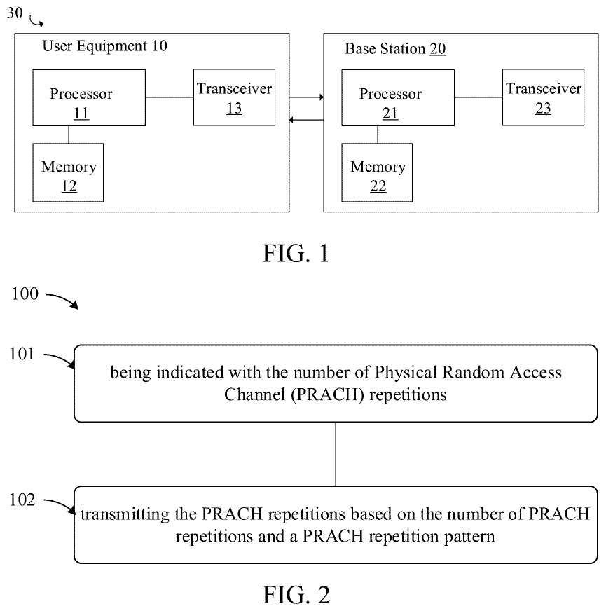

FIG. 2 illustrates a coverage enhancement method according to an embodiment of the present application. In some embodiments, referring to FIG. 2 in conjunction with FIG. 1, the method 100 includes the following.

In Step 101, the UE 10 is indicated by the base station 20 with the number of Physical Random Access Channel (PRACH) repetitions.

In current version (Rel-17) of 3GPP specification, for 4-step RACH, the time-frequency resources for a RO is indicated by SIB1, and UE occupies a RO to transmit the RACH sequence and the transmission is not repeated. A repeat mechanism could be considered for PRACH.

This disclosure proposes method(s) to support multiple PRACH transmissions with a same beam or multiple beams for RACH. When multiple PRACH transmissions are enabled, how to indicate the number of PRACH repetitions should be determined. The following approaches could be considered for indicating multiple PRACH transmissions.

In a first possible implementation, the number of PRACH repetitions is indicated by system information block 1 (SIB1). SIB1 is periodically transmitted from the base station to the UE by broadcasting. For example, the base station may transmit SIB1 that carries an information element including a parameter used to indicating the number of PRACH repetitions. According to the number of PRACH repetitions, the UE transmits PRACH repetitions to the base station to reduce the possibility of failure of PRACH transmission, thereby achieving coverage enhancement.

In an exemplary example, a parameter can be added into RACH-ConfigGeneric or RACH-ConfigGenericTwoStepRA information element defined in TS 38.331 for indicating the number of repetitions of PRACH (If two-step RACH is used, the IE can be added in RACH-ConfigGenericTwoStepRA information element). The RACH-ConfigGeneric IE is used to specify the cell specific random-access parameters both for regular random access as well as for beam failure recovery. An example of new RACH-ConfigGeneric IE is illustrated in Table 1 below, where the parameter (i.e., RA-RepK) is for indicating the number of PRACH repetitions. The candidate number of PRACH repetitions could be {1,2,3,4,6,8, 12,16}. If the parameter RA-RepK is not configured or the number of repetitions of PRACH is configured as 1 by the parameter RA-RepK, it means the UE does not need to repeat PRACH transmission. If the number of repetitions of PRACH is configured as 2, 3, 4, 6, 8, 12 or 16 by the parameter RA-RepK, the UE transmits 2, 3, 4, 6, 8, 12 or 16 PRACH repetitions to the base station, respectively. That is, the value of the parameter RA-RepK corresponds to the number of PRACH repetitions.

TABLE 1
RACH-ConfigGeneric information element

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| RA-RepK | ENUMERATED {n1, n2, n3, n4, n6, n8, n12, n16}, |
| msg1-FrequencyStart | INTEGER (0..maxNrofPhysicalResourceBlocks-1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, |

n100, n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| prach-ConfigurationPeriodScaling-IAB-r16 | ENUMERATED |
| {scf1,scf2,scf4,scf8,scf16,scf32,scf64} | OPTIONAL, -- Need R |
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-ResponseWindow-v1610 | ENUMERATED { sl60, sl160} |

OPTIONAL,-- Need R

| | |
|---|---|
| prach-ConfigurationIndex-v1610 | INTEGER (256..262) |

OPTIONAL -- Need R
]]
}
-- TAG-RACH-CONFIGGENERIC-STOP
-- ASN1STOP

In a second possible implementation, the number of PRACH repetitions is indicated by system information block 1 (SIB1). SIB1 is periodically transmitted from the base station to the UE by broadcasting. For example, the base station may transmit SIB1 that carries one of random access configurations, and the one random access configuration is indicated by PRACH configuration index. The one random access configuration includes a value representive of the number of PRACH repetitions. According to the number of PRACH repetitions, the UE transmits PRACH repetitions to the base station to reduce the possibility of failure of PRACH transmission, thereby achieving coverage enhancement.

In an exemplary example, a new column can be added into the “Random access configurations” table defined in TS 38.211, where the value recorded in the new column is used for indicating the number of repetitions of PRACH. An example of new “Random access configurations” table is illustrated in Table 2 below, where the column of RepK indicates the number of PRACH repetitions. The candidate number of PRACH repetitions could be {1,2,3,4,6,8,12,16}. If the number of repetitions of PRACH is configured as 1 in the column of RepK, it means the UE does not need do repeat RACH transmission. If the number of repetitions of PRACH is configured as 2, 3, 4, 6, 8, 12 or 16 in the column of RepK, the UE transmits 2, 3, 4, 6, 8,12 or 16 PRACH repetitions to the base station, respectively. That is, the value recorded in the column of RepK corresponds to the number of PRACH repetitions.

TABLE 2

| | | | | | | | Nₜ^{RA, slot}, | | |
|---|---|---|---|---|---|---|---|---|---|
| | | | | | | | number of | | |
| | | | | | | | time-domain | | |
| | | | | | | Number of | PRACH | | |
| PRACH | | n_{f} mod | | | | PRACH | occasions | N_{dur}^{RA}, | |
| Config. | Preamble | x = y | | | Starting | slots within | within a | PRACH | |
| Index | format | x | y | Slot number | symbol | a 60 kHz slot | PRACH slot | duration | RepK |

Omit

| | | | | | | | | | |
|---|---|---|---|---|---|---|---|---|---|
| 130 | B4 | 1 | 0 | 7, 15, 23, 31, 39 | 0 | 2 | 1 | 12 | 2 |
| 131 | B4 | 1 | 0 | 23, 27, 31, 35, 39 | 0 | 1 | 1 | 12 | 4 |
| 132 | B4 | 1 | 0 | 23, 27, 31, 35, 39 | 2 | 2 | 1 | 12 | 8 |

Omit

As illustrated in Table 2, when the prach-ConfigurationIndex indicates 130, then the PRACH repetition number is 2; when the prach-ConfigurationIndex indicates 131, then the PRACH repetition number is 4; when the prach-ConfigurationIndex indicates 132, then the PRACH repetition number is 8. The PRACH format and the time domain resource for the RO is determined based on the other parameters within the same row as indicated by the prach-ConfigurationIndex.

In Step 102, the UE 10 transmits the PRACH repetitions to the base station 20 based on the number of PRACH repetitions and a PRACH repetition pattern.

When the number of repetitions of PRACH is indicated, the PRACH repetition pattern needs to be determined in order to avoid ambiguous between the base station (e.g., gNB) and the user equipment (UE). The PRACH repetition pattern can be preset in the UE, or configured by the base station, or determined based on other parameters. The following approaches to determine the PRACH repetition pattern can be considered.

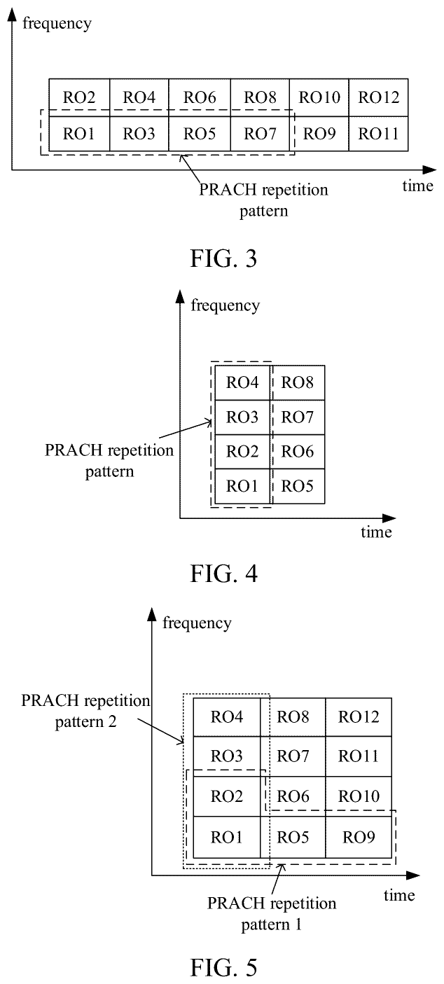

In a first possible implementation, the PRACH repetition pattern is based on time domain ROs, where the time domain ROs mean ROs which have the same frequency resource and different time resources. In some cases, an individual PRACH repetition pattern only includes the ROs having the same frequency resource. For instance, as shown in FIG. 3, 6 time domain ROs within a RACH slot and 2 frequency-division multiplexing (FDM) ROs are configured by SIB1, and the index of the ROs is 1 to 12. When the number of repetitions for PRACH is configured as 4 by the base station, then the UE repeats the PRACH with RO1, RO3, RO5, RO7.

In some embodiments, the repetitions of PRACH of an individual PRACH repetition pattern does not cross PRACH slot boundary (i.e., the boundary of one PRACH slot). In some embodiments, the repetitions of PRACH of an individual PRACH repetition pattern can be cross the PRACH slot boundary (i.e., cross over a plurality of PRACH slots).

In some embodiments, the repetitions of PRACH of an individual PRACH repetition pattern are back-to-back (or consecutive) based on ROs (e.g., time domain ROs) within a PRACH slot. In some embodiments, the PRACH is repeated within multiple PRACH slots, each PRACH slot can only repeat once and the same RO is allocated. In some embodiments, the PRACH is repeated within multiple PRACH slots, each PRACH slot includes one or more ROs, the repetition of PRACH is back-to-back or consecutive within multiple ROs within the PRACH slots.

In a second possible implementation, the PRACH repetition pattern is based on frequency domain ROs, where the frequency domain ROs mean ROs which have the same time resource and different frequency resources. In some cases, an individual PRACH repetition pattern only includes the ROs having the same time resource. For instance, as shown in FIG. 4, 2 time domain ROs within a RACH slot and 4 FDM ROs are configured by SIB1, and the index of the ROs is 1 to 8. When the number of repetitions for PRACH is configured as 4 by the base station, then the UE repeats the PRACH with RO1, RO2, RO3, RO4.

In some embodiments, the repetitions of PRACH of an individual PRACH repetition pattern does not cross PRACH slot boundary (i.e., the boundary of one PRACH slot). In some embodiments, the repetitions of PRACH of an individual PRACH repetition pattern can be cross the PRACH slot boundary (i.e., cross over a plurality of PRACH slots). In some embodiments, the repetitions of PRACH of an individual PRACH repetition pattern are back-to-back (or consecutive) based on frequency domain ROs within a PRACH slot. In some embodiments, the PRACH is repeated within multiple PRACH slots, each PRACH slot can only repeat once and the same RO is allocated. In some embodiments, the PRACH is repeated within multiple PRACH slots, each PRACH slot includes one or more ROs, the repetition of PRACH is back-to-back or consecutive within multiple ROs within the PRACH slots.

In a third possible implementation, the PRACH repetition pattern is based on time and frequency domain ROs and time domain ROs first. For instance, as shown in FIG. 5, 3 time domain ROs within a RACH slot and 4 FDM ROs are configured by SIB1, and the index of the ROs is 1 to 12. When the number of repetitions for PRACH is configured as 4 by the base station, then the UE repeats the PRACH with RO1, RO5, RO9, RO2 in order. In some embodiments, the PRACH repetition pattern is based on time and frequency domain ROs and frequency domain ROs first. For instance, as shown in FIG. 5. When the number of repetitions for PRACH is configured as 4 by gNB, then the UE repeats the PRACH with RO1, RO2, RO3, RO4 in order.

In some embodiments, the repetitions of PRACH of an individual PRACH repetition pattern does not cross PRACH slot boundary (i.e., the boundary of one PRACH slot). In some embodiments, the repetitions of PRACH of an individual PRACH repetition pattern can be cross the PRACH slot boundary (i.e., cross over a plurality of PRACH slots). In some embodiments, the repetitions of PRACH of an individual PRACH repetition pattern are back-to-back (or consecutive) based on time and frequency domain ROs and time domain ROs first. In some embodiments, the repetitions of PRACH of an individual PRACH repetition pattern are back-to-back (or consecutive) based on time and frequency domain ROs and frequency domain ROs first. In some embodiments, the PRACH is repeated within multiple PRACH slots, each PRACH slot can only repeat once and the same RO is allocated. In some embodiments, the PRACH is repeated within multiple PRACH slots, each PRACH slot includes one or more ROs, the repetition of PRACH is back-to-back or consecutive within multiple ROs within the PRACH slots.

The coverage enhancement method may also includes a step of mapping multiple Synchronization Signal Blocks (SSBs) to PRACH repetition ROs.

During cell search procedure Synchronization Signal Blocks (SSBs) are used, where the UE searches for the synchronization signals for getting a cell information to get attach with that cell and accesses radio network services. In current version (Rel-17) of 3GPP specification, for RACH access procedure, the beam information is carried by RACH occasion, and when the PRACH repetition transmission is enabled, the relationship between SSBs and ROs need to be modified.

This disclosure proposes method(s) to determine the relationship between SSBs and multiple PRACH transmission occasions. The fundamental principle to determine the relationship between SSBs and ROs is using same beam index for PRACH repetitions. The following approaches to determine the relationship between SSBs and multiple PRACH repetition transmission occasions can be considered.

When multiple SSBs are mapped to PRACH repetition ROs, it may be considered that one SSB is mapped to a set of ROs and the set of ROs are the PRACH repetition ROs. In some situations, a first SSB is mapped to the first PRACH repetition ROs (i.e., the ROs for PRACH repetitions that are configured or preconfigured first or to be used first) and a second SSB is mapped to the second PRACH repetition ROs (i.e., the ROs for PRACH repetitions that are configured or preconfigured secondly or to be used secondly), and the remaining SSBs are mapped to the remaining groups of PRACH repetition transmission occasions (TOs) in order. More specifically, the PRACH repetition ROs are determined based on the PRACH repetition patterns.

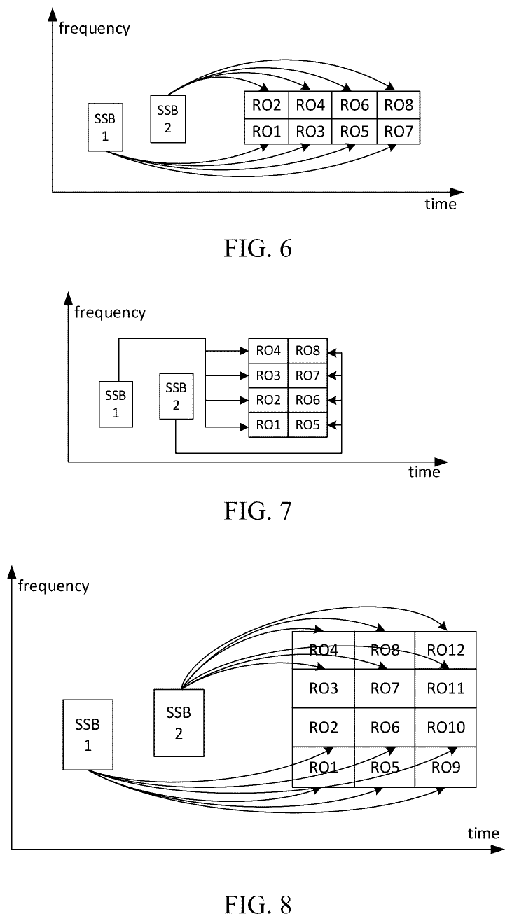

In a first possible implementation, if the PRACH repetition pattern is based on time domain ROs, then a SSB is mapped to multiple time domain ROs. The first SSB maps to a first set of multiple time domain ROs and the second SSB maps to a second set of multiple time domain ROs. For instance, as shown in FIG. 6, the number of PRACH repetitions is configured as 4 and the PRACH repeats based on time domain ROs as shown in FIG. 3, and the number of actual SSBs is 2. Then, SSB1 is mapped to {RO1, RO3, RO5, RO7}, and SSB 2 is mapped to {RO2, RO4, RO6, RO8}. In some embodiments, a SSB can map to a group of PRACH repetition ROs, where a group of PRACH repetition ROs means all ROs within multiple PRACH repetitions, wherein the multiple PRACH repetitions can be configured by the base station, for example, by SIB1. In some embodiments, multiple SSBs can map to a PRACH repetition RO.

In a second possible implementation, if the PRACH repetition pattern is based on frequency domain ROs, then a SSB is mapped to multiple frequency domain ROs. The first SSB maps to a first set of multiple frequency domain ROs and the second SSB maps to a second set of multiple frequency domain ROs. For instance, as shown in FIG. 7, the number of PRACH repetitions is configured as 4 and the PRACH repeats based on frequency domain ROs as shown in FIG. 4, and the number of actual SSBs is 2. Then, SSB1 is mapped to {RO1, RO2, RO3, RO4}, and SSB2 is mapped to {RO5, RO6, RO7, RO8}. In some embodiments, a SSB can map to a group of PRACH repetition ROs, where a group of PRACH repetition ROs mean all ROs within multiple PRACH repetitions, wherein the multiple PRACH repetitions can be configured by the base station, for example, by SIB1. In some embodiments, multiple SSBs can map to a PRACH repetition RO.

In a third possible implementation, if PRACH repetition is based on time and frequency domain ROs and time domain ROs first. A SSB can be mapped to multiple time and frequency domain ROs. The first SSB maps to a first set of multiple time and frequency domain ROs and the second SSB maps to a second set of multiple time and frequency domain ROs. For instance, as shown in FIG. 8, the number of PRACH repetitions is configured as 6 and the PRACH repeats based on time and frequency domain ROs as shown in FIG. 5 (similar to PRACH repetition pattern 1), and the number of actual SSBs is 2. Then, SSB1 is mapped to {RO1, RO5, RO9, RO2, RO6, RO10}, and SSB2 is mapped to {RO3, RO7, RO11, RO4, RO8, RO12}. In some embodiments, a SSB can map to a group PRACH repetition ROs, where a group of PRACH repetition ROs mean all ROs within the PRACH repetitions duration.

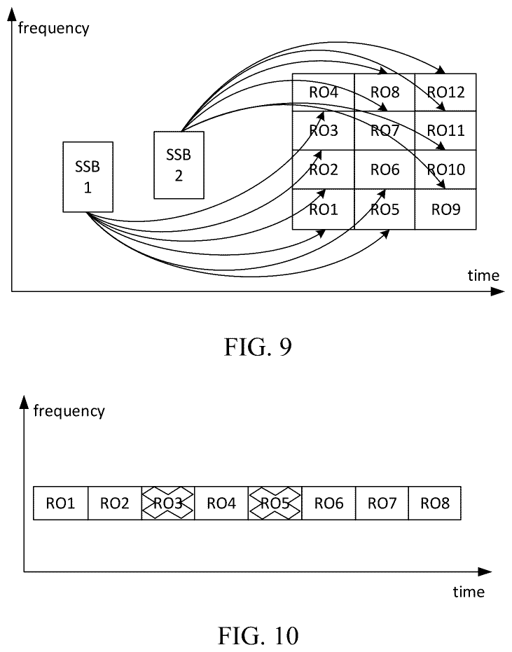

In a fourth possible implementation, if PRACH repetition is based on time and frequency domain ROs and frequency domain RO first. A SSB can be mapped to multiple valid time and frequency domain ROs. The first SSB maps to a first set of multiple time and frequency domain ROs and the second SSB maps to a second set of multiple time and frequency domain ROs. For instance, as shown in FIG. 9, the number of PRACH repetitions is configured as 6 and the PRACH repeats based on time and frequency domain ROs as shown in FIG. 5 (similar to PRACH repetition pattern 2), and the number of actual SSBs is 2. Then SSB1 is mapped to {RO1, RO2, RO3, RO4, RO5, RO6}, and SSB2 is mapped to {RO7, RO8, RO9, RO10, RO11, RO12}. In some embodiments, a SSB can map to a group PRACH repetition ROs, where a group of PRACH repetition ROs mean all ROs within the PRACH repetitions duration.

When multiple PRACH transmissions are enabled, if one of PRACH repetitions is collided with other transmissions or frame structure, how the PRACH repetition transmissions are needs to be determined.

This disclosure propose method(s) to support multiple PRACH transmissions with the same beam or multiple beams for RACH and how to count the number of PRACH repetitions. In addition, potential ways for early termination of PRACH repetition is also given. The following approaches can be considered.

In a first possible implementation, the number of PRACH repetitions is based on nominal ROs. The transmission occasions of PRACH repetition does not exceed the occasions which are configured by the base station (for example, by SIB 1). In other words, the number of PRACH repetitions is counted based on the configured ROs, no matter the RACH sequence is transmitted or not in the configured ROs. For instance, as shown in FIG. 10, 8 time domain ROs within one or multiple PRACH slots and 1 FDM ROs are configured by SIB1, the index of the ROs is 1 to 8, the RO3 and RO5 are collided with frame structure or other transmissions, and the number of repetitions of PRACH is configured as 6. Then, the PRACH repeats on {RO1, RO2, RO3, RO4, RO5, RO6}, the actual number of PRACH repetitions is 4, and the actual PRACH repetitions are transmitted on {RO1, RO2, RO4, RO6}.

In a second possible implementation, the number of PRACH repetitions is based on available ROs. The transmission occasions of PRACH repetition is equal to the available RACH occasions (and may exceed the configured occasions). In other words, a PRACH repetition is not counted to the total number of PRACH repetitions if the RACH sequence is not transmitted in the RO or the RO is not available for the RACH sequence. For instance, as shown in FIG. 10, 8 time domain ROs within one or multiple RACH slots and 1 FDM ROs are configured by SIB1, the index of the ROs is 1 to 8, the RO3 and RO5 are not available ROs due to collision with frame structure or other transmissions, and the number repetitions of PRACH is configured as 6. Then, the PRACH repeats on {RO1, RO2, RO4, RO6, RO7, RO8}, and the actual number of PRACH repetitions is 6.

The coverage enhancement method may also includes a step of terminating transmission of the PRACH repetitions upon receiving a Random Access Response (RAR). More specifically, the base station can transmit a RAR to the UE. Once the UE receives the RAR from the base station during transmission of the PRACH repetitions, the transmission of PRACH repetitions may be terminated.

When the ROs configured by SIB1 cross multiple PRACH slots (for time-divisional demultiplexing (TDD), the ROs may cross multiple non-consecutive physical slots), a Random Access Response (RAR) can be transmitted by the base station in or between multiple non-consecutive physical slots. If a RAR is received by the UE during the PRACH repetition transmission, there is no need for the UE to transmit the remaining PRACH repetitions for power saving and releasing RO resources. That is to say, the transmission of PRACH repetitions should be terminated when a RAR is received by the UE during the PRACH repetition transmission.

The coverage enhancement method may also includes a step of being configured to dynamic switch waveform for UL channel(s) between Cyclic Prefix (CP)-orthogonal frequency-division multiplexing (OFDM) and discrete fourier transform-spread (DFT-S)-OFDM.

In current version (Rel-15˜17) of 3GPP specification, the waveform for UL channel(s) is configured by RRC semi-statically. When the waveform of UL channel is configured as CP-OFDM, it's not suitable for coverage limited scenarios due to its high Peak-to-Average Power Ratio (PAPR). For coverage limited scenarios, the waveform switching between CP-OFDM and DFT-S-OFDM according RRC re-configuration leads to large lantency.

This disclosure propose methods to support dynamic switching waveform for UL channels. The UL channels includes at least one of PUSCH, PUCCH or PRACH on which Msg3 is transmitted. The following approaches for dynamic switching waveform for UL channels between CP-OFDM and DFT-S-OFDM can be considered.

In a first possible implementation, a new field in Downlink Control Information (DCI) is introduced for indicating the waveform for UL channels explicitly. For example, the size of the field is 1 bit. The state “0” indicates the waveform for UL channel is CP-OFDM and the state “1” means the waveform for UL channel is DFT-S-OFDM; or, the state “1” indicates the waveform for UL channel is CP-OFDM and the state “0” means the waveform for UL channel is DFT-S-OFDM. In some embodiments, both types of the waveform can be not configured by RRC. In some embodiments, both types of the waveform can be further configured (by RRC).

For uplink transmission, there are two types of configured grant (CG) PUSCH transmission, that is, Type 1 and Type 2. In Type 1 CG PUSCH transmission, RRC signalling configures time domain resource allocation including periodicity of CG resources, offset, start symbol and length of PUSCH as well as the number of PUSCH repetitions. In Type 2 CG PUSCH transmission, only periodicity and the number of PUSCH repetitions are configured by RRC signalling. The other time domain parameters are configured through an activation DCI. CG resources might be shared among several UEs based on contention-based access.

In some embodiments, for configured grant (CG) type 1 PUSCH transmission, a new IE can be added into a RRC-configured uplink grant configuration, such as the “rrc-ConfiguredUplinkGrant”defined in TS 38.331. The function of the new I.E., is used for indicating the waveform for PUSCH between CP-OFDM and DFT-S-OFDM. The new IE “waveform” is listed in the following new “rrc-ConfiguredUplinkGrant”, as illustrated in Table 3 below.

TABLE 3

| | |
|---|---|
| rrc-ConfiguredUplinkGrant | SEQUENCE { |
| timeDomainOffset | INTEGER (0..5119), |
| waveform | ENUMERATED {CP-OFDM, DFT-S-OFDM} |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs- |

```
1),
    ...,
    [[
```

| | |
|---|---|
| pusch-RepTypeIndicator-r16 | ENUMERATED {pusch-RepTypeA,pusch- |
| RepTypeB} | OPTIONAL, -- Need M |
| frequencyHoppingPUSCH-RepTypeB-r16 | ENUMERATED {interRepetition, interSlot} |

OPTIONAL, -- Cond RepTypeB

| | |
|---|---|
| timeReferenceSFN-r16 | ENUMERATED {sfn512} |

OPTIONAL -- Need S
]]
}

In a second possible implementation, the UL channel waveform is determined by an implicit way. A straightforward way to dynamic switching waveform for UL channel is introducing a new field in DCI; however, introducing a new field into DCI may decrease the performance of PDCCH, for example, increasing the blockage rate of PDCCH. Thus, an implicit way can be considered. In this implicit way, the waveform for UL channel is associated with other features of coverage enhancement methods in Rel-17. This is a suitable way. In other words, when some or any one coverage enhancement features in Rel-17 is enabled, then the waveform for UL channel is DFT-S-OFDM. Otherwise, the waveform for UL channel is CP-OFDM. For instance, when the transport block processing over multiple slots (TBoMS) PUSCH is enabled, then the waveform for PUSCH is DFT-S-OFDM. The following features in Rel-17 coverage enhancement can be used for triggering waveform switching for UL channels.
TBOMS is enabled
Msg 3 repetition is enabled
Joint channel estimation is enabled, e.g. time window size is configured.
PUSCH repetition is based on available slots
The maximum number of PUSCH repetitions is configured as 32

In some embodiments, a default waveform for UL chennels can be set as CP-OFDM. In some embodiments, both types of the waveform can be not configured by RRC. In some embodiments, both types of the waveform can be further configured (by RRC).

In a third possible implementation, a field in DCI is reused for indicating the waveform for UL channels explicitly. For coverage limited scenarios, in marjory of case, high MCS is not used, so I most significant bit (MSB) of MCS can be resued for indicating the waveform of UL channels. The state “0” indicates the waveform for UL channle is CP-OFDM and the state “1” means the waveform for UL channle is DFT-S-OFDM; or, the state “1” indicates the waveform for UL channle is CP-OFDM and the state “0” means the waveform for UL channle is DFT-S-OFDM. The following fields can be resued for waveform indication (1 MSB).
MCS (Modulation and Coding Scheme)
FDRA (Frequency Domain Resource Allocation)
TPC (Transmit Power Control)

In some embodiments, a default waveform for UL chennels can be set as CP-OFDM. In some embodiments, both types of the waveform can be not configured by RRC. In some embodiments, both types of the waveform can be further configured (by RRC).

In a fourth possible implementation, a Media Access Control (MAC) Control Element (CE) is used for indicating the waveform for UL channels explicitly. In some embodiments, both types of the waveform can be not configured by RRC. In some embodiments, both types of the waveform can be further configured (by RRC).

Commercial interests for some embodiments are as follows. 1. Solving issues in the prior art. 2. Carrying out coverage enhancement. 3. Achieving better coverage performance. 4. Realizing mapping between SSBs and multiple PRACH transmission occasions. 5. Realizing dynamic switching waveform for UL channels. 6. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiment of the present application. For brevity, details will not be described herein again.

The embodiment of the present application further provides a computer program product including computer program instructions. The computer program product enables a computer to execute corresponding processes implemented by the UE/BS in each of the methods of the embodiment of the present application. For brevity, details will not be described herein again.

The embodiment of the present application further provides a computer program. The computer program enables a computer to execute corresponding processes implemented by the UE/BS in each of the methods of the embodiment of the present application. For brevity, details will not be described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A coverage enhancement method, performed by a user equipment (UE), the method comprising:
being indicated with the number of Physical Random Access Channel (PRACH) repetitions; and
transmitting the PRACH repetitions based on the number of PRACH repetitions and a PRACH repetition pattern.

2. The method of claim 1, wherein the number of PRACH repetitions is indicated by a parameter of an information element (IE) carried in system information block 1 (SIB1).

3-4. (canceled)

5. The method of claim 1, wherein the PRACH repetition pattern is based on time domain Random Access Channel (RACH) occasions (ROs), where the time domain ROs mean ROs which have the same frequency resource and different time resources.

6-9. (canceled)

10. The method of claim 1, wherein for an individual PRACH repetition pattern, the PRACH repetitions are back-to-back or consecutive ROs within a PRACH slot or multiple PRACH slots.

11-12. (canceled)

13. The method of claim 1, further comprising:
mapping multiple Synchronization Signal Blocks (SSBs) to PRACH repetition ROs.

14. The method of claim 13, wherein a SSB is mapped to a set of ROs, and the set of ROs are the PRACH repetition ROs.

15-17. (canceled)

18. The method of claim 1, wherein the number of PRACH repetitions is based on available ROs.

19. (canceled)

20. The method of claim 1, further comprising:
being configured to dynamic switch waveform for uplink (UL) channel between Cyclic Prefix (CP)-orthogonal frequency-division multiplexing (OFDM) and discrete Fourier transform-spread (DFT-S)-OFDM.

21. The method of claim 20, wherein a field in Downlink Control Information (DCI) is used for indicating the waveform for UL channel explicitly.

22. The method of claim 21, wherein a first value of a bit in the field of DCI indicates the waveform for UL channel is the DFT-S-OFDM and a second value of the bit in the field of DCI indicates the waveform for UL channel is the CP-OFDM.

23-26. (canceled)

27. A coverage enhancement method, performed by a base station (BS), the method comprising:
indicating a user equipment (UE) with the number of Physical Random Access Channel (PRACH) repetitions; and
receiving from the UE the PRACH repetitions based on the number of PRACH repetitions and a PRACH repetition pattern.

28. The method of claim 27, wherein the number of PRACH repetitions is indicated by a parameter of an information element (IE) carried in system information block 1 (SIB1).

29-30. (canceled)

31. The method of claim 27, wherein the PRACH repetition pattern is based on time domain Random Access Channel (RACH) occasions (ROs), where the time domain ROs mean ROs which have the same frequency resource and different time resources.

32-52. (canceled)

53. A user equipment (UE), communicating with a base station (BS) in a network, the UE comprising a processor, configured to call and run program instructions stored in a memory, to execute a coverage enhancement method, wherein the method comprises:
being indicated with the number of Physical Random Access Channel (PRACH) repetitions; and
transmitting the PRACH repetitions based on the number of PRACH repetitions and a PRACH repetition pattern.

54-57. (canceled)

58. The UE of claim 53, wherein for an individual PRACH repetition pattern, the PRACH repetitions are back-to-back or consecutive ROs within a PRACH slot or multiple PRACH slots, and a SSB is mapped to a set of ROs, and the set of ROs are PRACH repetition ROs.

59. The UE of claim 53, wherein the number of PRACH repetitions is indicated by a parameter of an information element (IE) carried in system information block 1 (SIB1).

60. The UE of claim 53, wherein the PRACH repetition pattern is based on time domain Random Access Channel (RACH) occasions (ROs), where the time domain ROs mean ROs which have the same frequency resource and different time resources.

61. The UE of claim 53, wherein for an individual PRACH repetition pattern, the PRACH repetitions are back-to-back or consecutive ROs within a PRACH slot or multiple PRACH slots.

62. The UE of claim 53, wherein the processor is further configured to map multiple Synchronization Signal Blocks (SSBs) to PRACH repetition ROs.

63. The UE of claim 53, wherein a SSB is mapped to a set of ROs, and the set of ROs are the PRACH repetition ROs.
